(19) United States
(12) Patent Application Publication
(10) Pub. No.: US 2017/0104367 A1
(43) Pub. Date: Apr. 13, 2017

(54) SYSTEMS AND METHODS FOR AN ELECTRICAL POWER CONNECTOR

(71) Applicants: Micah Laughmiller, Benbrook, TX (US); Dan Black, Temple, TX (US)

(72) Inventors: Micah Laughmiller, Benbrook, TX (US); Dan Black, Temple, TX (US)

(21) Appl. No.: 15/275,414

(22) Filed: Sep. 25, 2016

Related U.S. Application Data
(60) Provisional application No. 62/240,346, filed on Oct. 12, 2015.

(51) Int. Cl. H02J 50/10; H01F 27/28; H01F 27/40; H01R 24/30; H02J 50/70

(52) U.S. Cl. CPC H02J 50/10; H01R 24/30; H02J 50/70; H01F 27/402; H01F 27/28; H01F 2027/406

(57) ABSTRACT

Embodiments disclosed herein describe systems and methods for electrical power connectors where power is transferred through electromagnetic induction. Embodiments may lead to a safer form of power transmission that may save lives and dollars every year.

### CROSS-REFERENCE TO RELATED APPLICATIONS

This application claims a benefit of priority under 35 U.S.C. §119 to Provisional Application No. 62240346 filed on Oct. 12, 2015, which is fully incorporated herein by reference in its entirety.

### BACKGROUND INFORMATION

Field of the Disclosure

Examples of the present disclosure are related to systems and methods for an electrical power connector. More particularly, embodiments disclose a device that is configured transfer power through electromagnetic induction between two separable connectors, wherein the two separable connectors are coupled together by electromagnetism.

Background

Power plugs and sockets are devices that allow electrically operated equipment to be connected to a primary power supply in a building or via a generator. Electrical plugs and sockets differ in voltage and current rating, shape, size, and type of connectors. Conventional plugs and sockets operate by inserting a male connector (plugs) associated with an appliance within a corresponding female connector (sockets), which may be positioned on a wall.

Design features of plugs and sockets have gradually developed to reduce the risk of electric shock and fire. Safety measures may include pin and slot dimensions and layouts that permit only proper insertion of a plug into a socket. Further improvements to conventional plugs and sockets include grounded pins that are longer than power pins so an appliance becomes grounded before power is connected. Accordingly, to power and ground an appliance, pins associated with the plugs must directly insert into a socket, such that the pins directly contact slots associated with sockets. Thus, conventional plugs and sockets require direct physical contact to power appliances, which create risks of shock, fire, etc.

Accordingly, needs exist for more effective and efficient systems and methods for electrical power connectors where power is transferred through electromagnetic induction rather than electrical contact, which may ensure arc free and shock free use.

### SUMMARY

Embodiments disclosed herein describe systems and methods for electrical power connectors where power is transferred through electromagnetic induction over a wireless connection. Embodiments may lead to a safer form of power transmission that may save lives and dollars every year. Embodiments may include a first connector and a second connector.

The first connector may be a male connector configured to connect directly with an AC supply or an adapter to a conventional wall outlet. The first connector may include an inner core with primary windings of a transformer, spring loaded lock, plate cover, grounded leads, and electrical switch. The inner core may be comprised of iron or any other material suitable for electromagnetic induction.

The second connector may be a female connector configured to be coupled with an electrical device, appliance, adapter for electrical devices, etc. The second connector may include an inner core with secondary windings, grounded leads, and a metal plate. The inner core may be comprised of iron or any other material suitable for electromagnetic induction.

Responsive to coupling the first connector and the second connector by positioning the first connector adjacent to the second connector, the plate cover may be moved and the electrical switch may be activated. The electrical switch may be activated only when the first connector and the second connector are coupled to reduce, limit, etc. overheating.

In embodiments, when the first connector and second connector are coupled together, a full transformer may be formed. The winding ratios of the inner core associated with the first connector and the inner core associated with the second connector may be between 1:1.05-1.10, such that the winding ratio of the first connector is slightly less than that of the second connector. This may ensure that any losses of power transferred between the first connector and second connector may be limited, negated, and/or minimized.

Responsive to coupling the first connector and second connector, AC current received by the first connector may induce a magnetic field in the inner core of the first connector. The induction of the magnetic field in the inner core of the first connector may induce an electrical current in the inner core of the second connector forming electromagnetic induction. Through the electromagnetic induction, power may be transferred from an electrical grid to the first connector. The power may then be transferred from the first connector to the second connector via electromagnetic induction, and from the second connector to an electrical device. Thus, the power transfer may be completed without inserting a pins associated with the first connector within slots associated with the second connector, or vice versa.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a side cross sectional view of a device that is configured to transfer power through electromagnetic induction, according to an embodiment.

FIG. 2 depicts a top view of primary windings, according to an embodiment.

FIG. 3 depicts a side view of primary windings, according to an embodiment.

FIG. 4 depicts a top view of secondary windings, according to an embodiment.

FIG. 5 depicts a side view of secondary windings, according to an embodiment.

FIG. 6 depicts a front view of a plate, according to an embodiment.

FIG. 7 depicts an embodiment of a method utilizing a device to transfer power across two devices without voltage being transferred via a contacted wire across the devices.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

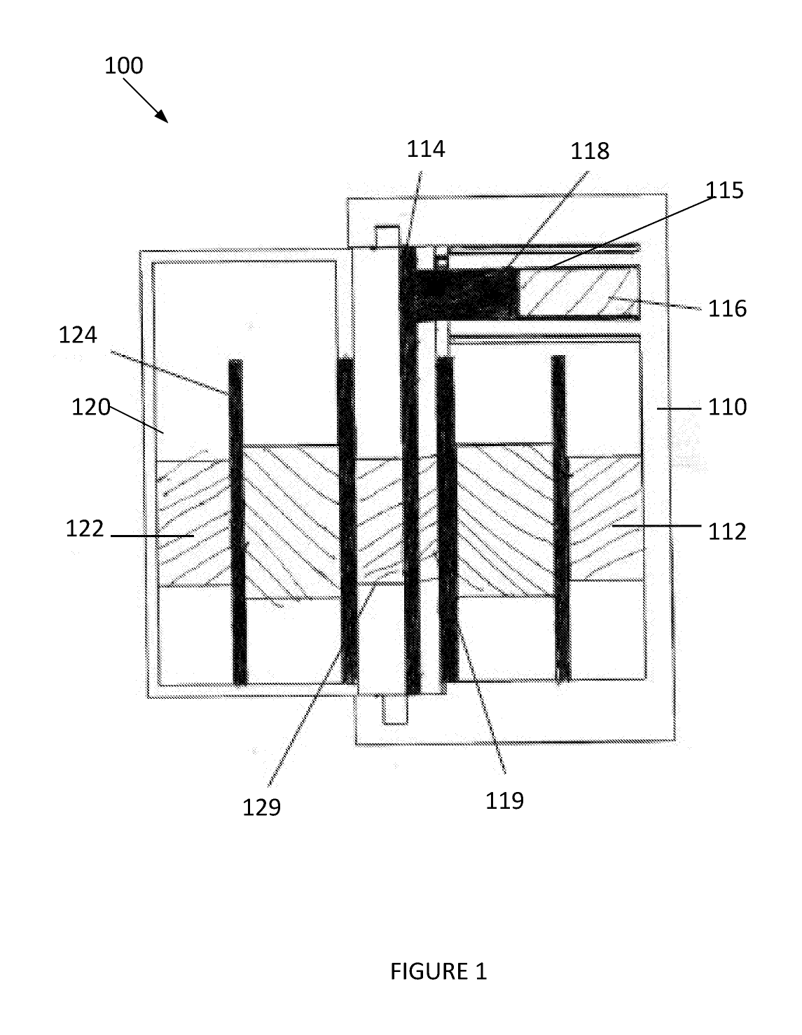

FIG. 1 depicts a side cross sectional view of device 100 that is configured to transfer power through electromagnetic induction, according to an embodiment. Device 100 may include a first connector 110 and a second connector 120.

First connector 110 may be a male connector configured to be coupled with an

AC power supply of an electric grid, or be an adapter for a conventional wall outlet. In embodiments where first connector 110 is directly coupled with the AC power supply of the electric grid, first connector 110 may be recessed within a wall of a building, surge protector, power strip, etc. In embodiments where first connector is an adapter for a conventional wall outlet, pins associated with first connector 110 may be inserted into the conventional wall outlet.

First connector 110 may include primary windings 112, plate 114, locking mechanism 116, switch 118, and first end connector 119.

Primary windings 112 may be a device that is configured to create magnetic flux in a transformer core, and create a magnetic field impinging on secondary windings 122 within second connector 120. The magnetic field created by primary windings 112 may induce a varying electromotive force or voltage in secondary windings 122. Utilizing Faraday's law in conjunction with magnetic permeability core properties between primary windings 112 and secondary windings 122, first connector 110 and second connector 120 may form a transformer that is configured to transfer AC voltages between two separate and removable devices, wherein the two separate and removable devices are first connector 110 and second connector 120.

Plate 114 may be a plate that is configured to cover a face of first connector 110. Plate 114 may have a planar sidewall extending across the face of first connector 100. Plate 114 may cover the face of first connector 110 to limit the exposure of primary windings 112 outside of a housing of first connector 110. Plate 114 may also be configured to cover slot 115 positioned with first connector 110, switch 118, and locking mechanism 115. In a first mode, plate 114 may be configured to be positioned planar to the face of first connector 110 when first connector 110 and second connector 120 are decoupled. Responsive to coupling first connector 110 and second connector 120, in a second mode, plate 114 may slide within first connector 110 to be recessed within first connector 110. Accordingly, plate 114 may be retracted within first connector 110 when first connector 110 and second connector 120 are coupled together.

Slot 115 may be a channel, groove, depression, etc. positioned within a housing of first connector 120. Slot 115 may be shaped to receive switch 118, such that portions of switch 118 may move in and out of slot 115.

Switch 118 may include a first side that is configured to be positioned adjacent to plate 114, and a second side that is configured to be positioned adjacent to locking mechanism 116 within slot 115. In embodiments, when first connector 110 and second connector 120 are decoupled, locking mechanism 116 may apply an outward force against the second side of switch 118. This outward force may cause switch 118 to not be fully inserted within slot 115. For example, locking mechanism 116 may be a spring, actuator, etc. that is configured to apply mechanical force to the second side of switch 118.

Responsive to a user coupling first connector 110 and second connector 120 by pressing second connector 120 towards the second end of switch 118, second connector 120 may apply sufficient mechanical force against locking mechanism 118 to overcome the force applied by locking mechanism 116 to switch 118. When overcoming the mechanical force applied by locking mechanism 116 to switch 118, switch 118 may move along a linear path and become fully inserted within slot 115.

Responsive to switch 118 being inserted within slot 115, first connector 110 may complete a circuit with the power supply. When the power supply associated with the electrical grid supplies voltage to primary windings 112, a transformer with secondary windings 122 may be formed. Alternatively, when switch 118 is not fully inserted within slot 115, a transformer between first connector 110 and second connector 120 may not be formed. This may limit the time periods when a completed circuit with first connector 110 is formed to limit, reduce, and/or eliminate overheating of primary windings 112.

Furthermore, responsive to first connector 110 and second connector 120 forming a full transformer, the electromagnetism forces between first winding 112 and second winding 122 may be stronger than the mechanical force of locking mechanism 116. Thus, when the full transformer is formed, electromagnetism may unify first connector 110 and/or second connector 120 without additional coupling mechanisms.

First end connector 119 may be a contact to ground, wherein first end connector may be configured to be grounded. When first connector 110 and second connector 120 are coupled together, first end connector 119 may be directly coupled with a second end connector 129 positioned on second connector 120. Responsive to coupling first end connector 119 and second end connector 129, device 100 may be grounded, which may prevent a user from being in contact with dangerous voltages if electrical insulation fails, limit the build-up of static electricity when handling flammable products or electrostatic-sensitive devices, etc.

Second connector 120 may be a female connector, with a first end configured to be coupled with an electrical device, appliance, adapter for electric devices, etc. A second end of second connector 120 may be separable from first connector 110, and may also be configured to be coupled with first connector 110. In embodiments, second connector 120 may be configured to be inserted into a recession, perimeter, groove, etc. within first connector 110. Responsive to positioning second connector 110 within the recession, a full transformer may be formed between first connector 110 and second connector 120. Electromagnetic forces formed between first connector 110 and second connector 120 may be strong enough to overcome opposite forces from locking mechanism 116. The second connector 120 may be decoupled from the first connector 110 when the circuit is formed by pulling on the second connector 120 to create forces that are greater than the electromagnetic forces.

Second connector 110 may include secondary windings 122, second end connector 129, and leads 124.

Secondary windings 122 may be a device that is configured to create magnetic flux in a transformer core, which may be parred with primary windings 112. The magnetic field within secondary windings 122 may induce a varying electromotive force or voltage in secondary windings 122. Utilizing Faraday's law in conjunction with magnetic permeability core properties between primary windings 112 and secondary windings 122, first connector 110 and second connector 120 may for a transformer that is configured to transfer AC voltages between two separate and removable devices, first connector 110 and second connector 120. In embodiments, the ratio of windings between primary windings 112 and secondary windings may be 1:1.05-110. This may ensure that any loses from the transformer arrangements may be negated. However, one skilled in the art may appreciate that the ratio of the windings may be utilized to scale up or down the voltages between the connectors.

Second end connector 129 may be a contact to ground that is configured to be grounded. Second end connector 129 may be directly coupled with a first end connector 119 when second connector 120 is coupled with first end connector 110. Responsive to coupling second end connector 129 and first end connector 119, device 100 may be grounded, which may prevent a user from being in contact with dangerous voltage if electrical insulation fails, limit the build-up of static electricity when handling flammable products or electrostatic-sensitive devices, etc.

Leads 124 may be devices that are configured to couple secondary winding 122 with an electronical device or to a receptacle to be an adapter. Accordingly, leads 124 may be configured to transport power from secondary windings 122 to a device.

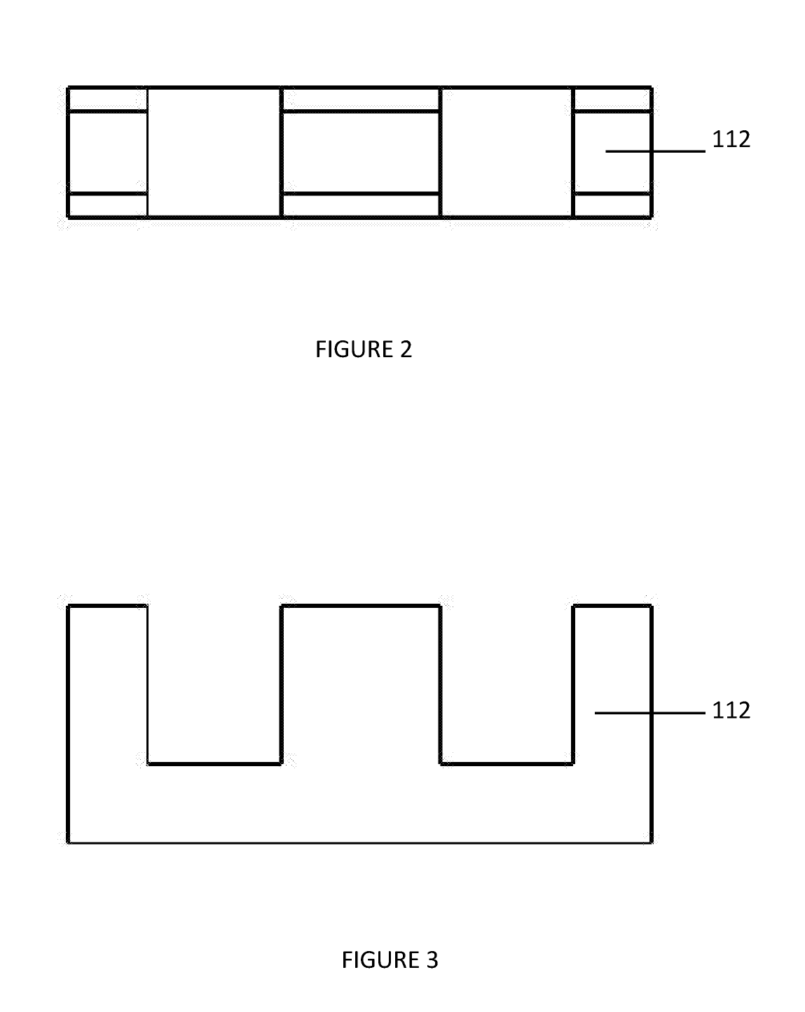

FIG. 2 depicts a top view of primary windings 112, and FIG. 3 depicts a side view of primary windings 112, according to an embodiment.

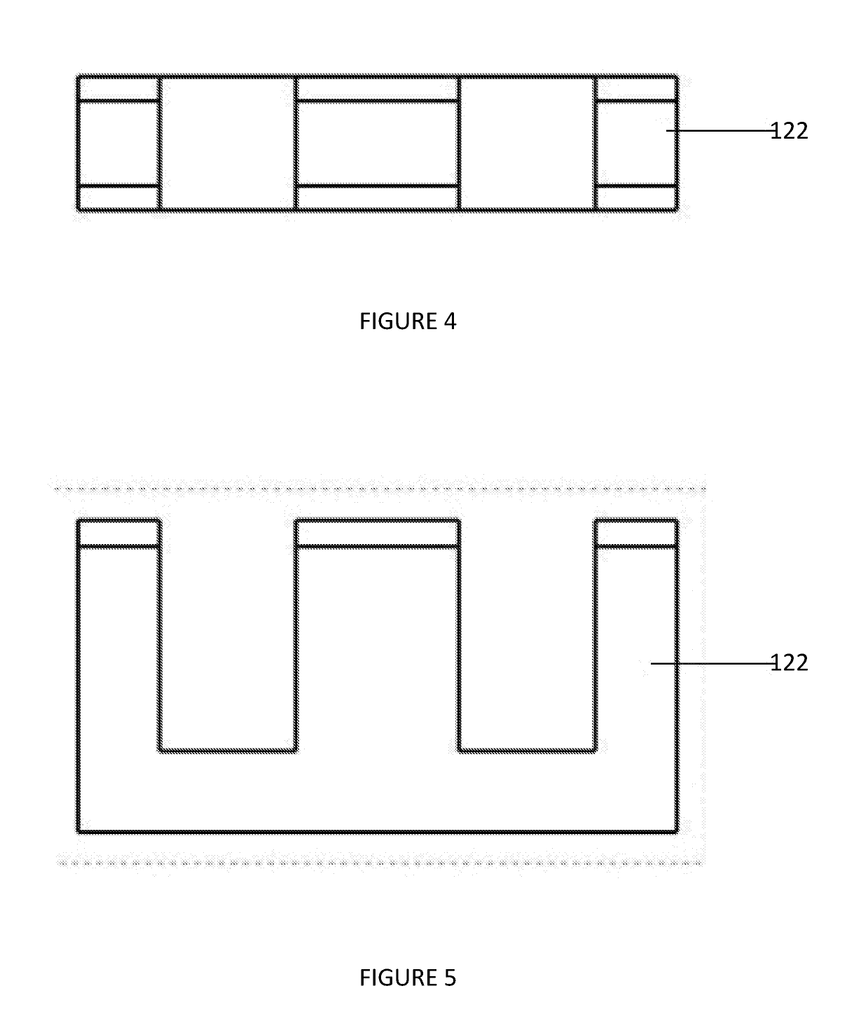

FIG. 4 depicts a top view of secondary windings 122, and FIG. 5 depicts a side view of secondary windings 122, according to an embodiment. In embodiments primary windings 112 are configured to pair with secondary windings to form a transformer.

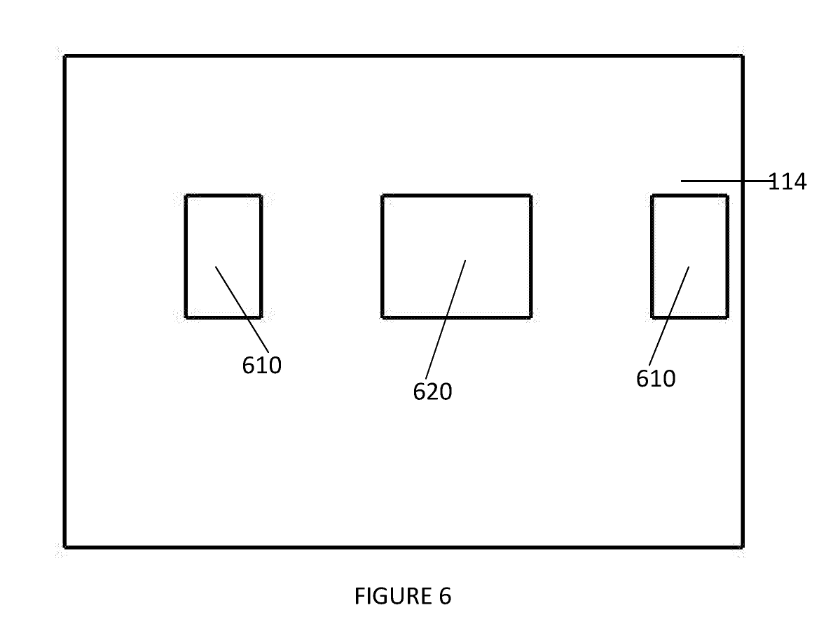

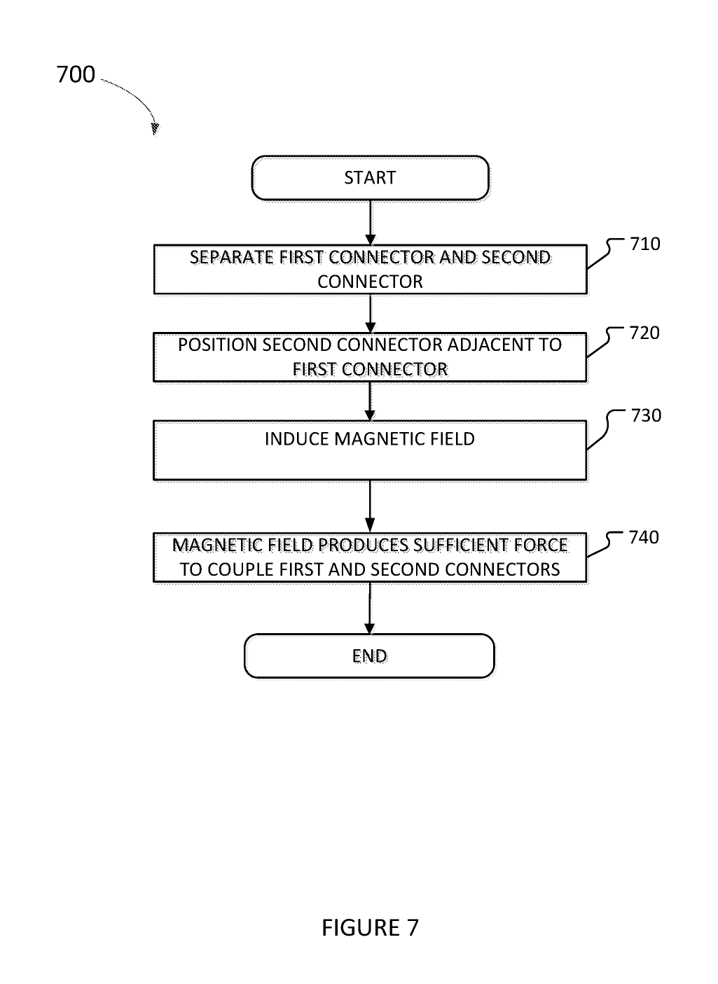

FIG. 6 depicts a front view of plate 114, according to an embodiment. As depicted in FIG. 6, plate 114 may a substantially planar surface with a plurality of orifices. Two of the plurality of orifices 610 may be configured to receive secondary windings 122 associate with secondary connector 120. A third of the plurality of orifices 620 may be configured to receive a grounded connection associated with secondary connector 120. FIG. 7 depicts an embodiment of a method 700 utilizing a device to transfer power across two devices without voltage being transferred via a contacted wire across the devices. The operations of method 700 presented below are intended to be illustrative. In some embodiments, method 700 may be accomplished with one or more additional operations not described, and/or without one or more of the operations discussed. Additionally, the order in which the operations of method 1100 are illustrated in FIG. 7 and described below is not intended to be limiting.

At operation 710, a first connector and a second connector may be decoupled from each other. When first connector and second connector are decoupled together, a switch within first connector may not be activated. Furthermore, when not connected, a spring within the first connector may be applying mechanical force against the switch to not allow the spring to be inserted into a slot. When the switch is not inserted into the channel, the primary windings associated with the first connector may not be receiving power from a power source.

At operation 720, a front face of the second connector may be positioned adjacent to a front face of the first connector. Force applied by a user to second connector to front connector may slide a plate on the front face of the first connector backwards, which may insert the switch into the slot.

At operation 730, responsive to the switch being inserted the slot, the primary windings on the first connector may receive current from a power source which may induce a magnetic field in the first connector and the second connector.

At operation 740, the magnetic fields in the first connector and the second connector may produce sufficient force to overcome the mechanical force of the spring within the slot. Thus, the magnetic field's forces may maintain the positioning of first connector with second connector without any additional external forces.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

What is claimed is:

1. An electrical power adapter comprising:
a first connector configured to be directly connected with a power supply, the first connector including primary windings;
a second connector configured to be coupled with an electrical device, the second connector including secondary wings, wherein the primary windings and the secondary windings are configured to form a transformer;
a plate configured to cover a face of the first connector, the plate being a planar surface;
a switch positioned on an inner surface of the plate, the switch being configured to move within a slot to form a circuit to form the transformer;
a locking mechanism configured to apply a first force in a first direction, wherein a second force in a second direction associated with the transformer is greater than the first force.

2. The adapter of claim 1, wherein the locking mechanism applies mechanical force in the first direction, and the second force applies electro-magnetical force in the second direction.

3. The adapter of claim 1, wherein the first force from the locking mechanism causes the switch to not be fully inserted into the slot until a third force moves the switch in the second direction.

4. The adapter of claim 3, wherein the primary windings associated with the first connector receive power from the power source responsive to inserting the switch into the slot when the third force is greater than the first force.

5. The adapter of claim 4, wherein the third force is a mechanical force.

6. The adapter of claim 1, wherein a ratio of windings between the primary windings to secondary windings is less than one.

7. The adapter of claim 1, wherein the locking mechanism is a spring and the second force causes the spring to compress.

8. The adapter of claim 1, wherein the first connector and second connector are removably coupled from each other.

9. The adapter of claim 1, wherein an outer perimeter of the second connector is configured to be encompasses by an inner perimeter of the first connector.

10. The adapter of claim 1, wherein the transformers transfers power over a wireless connection.

11. A method utilizing an electrical power adapter comprising:
directly connecting a first connector with a power supply, the first connector including primary windings;
coupling a second connector an electrical device, the second connector including secondary wings;
covering a face of the first connector with a plate, the plate being a planar surface;
applying, via a locking mechanism, a first force in a first direction against a switch;
moving a switch positioned on the inner surface of the plate within a slot in a second direction;
forming a wireless transformer between the primary windings and the secondary windings responsive to moving the switch in the second direction, wherein a second force in the second direction associated with the transformer is greater than the first force.

12. The method of claim 11, wherein the locking mechanism applies mechanical force in the first direction, and the second force applies electro-magnetical force in the second direction.

13. The method of claim 11, wherein the first force from the locking mechanism causes the switch to not be fully inserted into the slot until a third force moves the switch in the second direction.

14. The method of claim 13, wherein the primary windings associated with the first connector receive power from the power source responsive to inserting the switch into the slot when the third force is greater than the first force.

15. The method of claim 13, wherein the third force is a mechanical force.

16. The method of claim 11, wherein a ratio of windings between the primary windings to secondary windings is less than one.

17. The method of claim 11, wherein the locking mechanism is a spring and the second force causes the spring to compress

18. The method of claim 11, wherein the first connector and second connector are removably coupled from each other

19. The method of claim 11, wherein an outer perimeter of the second connector is configured to be encompasses by an inner perimeter of the first connector.

20. The method of claim 11, wherein the transformers transfers power over a wireless connection.
